(19) United States
(12) Patent Application Publication
(10) Pub. No.: US 2011/0106567 A1
(43) Pub. Date: May 5, 2011

(54) SYSTEM AND METHOD FOR INTELLIGENTLY TRACKING AND MANAGING CLAIM BASED CALCULATIONS

(75) Inventor: Ryan Asher, Elgin, IL (US)

(73) Assignee: Hartford Fire Insurance Company, Hartford, CT (US)

(21) Appl. No.: 12/609,443

(22) Filed: Oct. 30, 2009

(51) Int. Cl. G06Q 40/00; G06F 17/00

(52) U.S. Cl. 705/4; 715/205; 715/217; 715/764; 707/802; 715/212

(57) ABSTRACT

A method, system, apparatus, and computer-readable medium for managing and administering a spreadsheet-driven additional living expense calculators are disclosed. Third party data provides data input to the dynamic calculator and validation rules are implemented to preserve data integrity for calculating additional living expenses for policyholders. The system includes a graphical visual interface adapted to receive input of and display a plurality of additional living expense related values, an external data module for communicating one or more additional living expense related values for display on the graphical visual interface, a validation engine for validating the additional living expense values, the validation engine configured to compare a plurality of additional living expense input values with a plurality of additional living expense reference values, and to provide a visual indication based upon one or more of the comparisons, a calculation module for determining one or more payment values based on the validated additional living expense values and a communications module for providing instructions related to payment of the calculated additional living expense values.

### TECHNICAL FIELD

The present invention relates to automated calculation processing and more particularly to validating and supplementing calculations in a spreadsheet program running in a networked environment.

### BACKGROUND OF THE INVENTION

Insurance is a business of protecting and helping people after the occurrence of an accident, loss or tragedy. Property and casualty type insurance provides individuals and families with protection for their home, car and personal property. In the event of an accident or loss, an insurance claim is filed with the insurance company by a policyholder for payments/benefits as provided in an insurance policy. Policy holders must first file an insurance claim with the issuing insurance company and in certain circumstances provide proof of the loss before any money can be disbursed. Many times, the insurance companies may employ certain estimators and adjustors to verify the amount of the claim to be paid.

With claims related to permanent or temporary loss of housing, typically an insurance company will provide for certain compensation and benefits to assist during this period. Many times this will include providing temporary housing and reimbursing the policyholder for other expenses incurred during the time they have to maintain alternate housing as well as provide for the upkeep of their damaged home or apartment. Additional living expenses refer to expenses incurred and payments to be made for claimants who have experienced a loss affecting their housing, living conditions and lifestyles. For example, in the case of serious fire or flood, a policy holder may have to stay in temporary housing for a period of time and accordingly will incur expenses related to both their temporary housing as well as upkeep of the home or condominium being repaired. Expenses such as hotel or apartment rental, water, gas, electricity, phone and other related expenses may be incurred for both the temporary housing and their original home. Essentially, additional living expenses are quantifiable calculations that reflect a variety of lifestyle, housing and living expenses associated with the loss.

Additional living expenses are especially susceptible to error and fraud due to the great variety, circumstances and conditions surrounding what may be reasonable and proper expenses to help a policy holder maintain a similar standard or condition of living. For example, many subjective and objective factors are involved in determining an appropriate standard of living to provide to a policyholder upon a temporary loss of their residence. Factors such as economy, policy coverage limits, geographic area, type of loss incurred and other factors will impact whether an additional living expense for policyholder is proper. Currently, manual processes for managing, calculating and maintaining additional living expenses are vulnerable to human error, abuse and inaccuracies since insurance adjustors have to manually collect expense information and manually calculate these additional living expenses without proper mathematical and historical data controls.

Accordingly, it would be desirable to provide a system which eliminates many of these disadvantages of current additional living expense calculation, administration and management processes as well as providing insurance companies with an efficient and expedited way to manage and determine these additional living expenses.

It is with respect to these considerations and others that the various embodiments of the present invention have been made.

### BRIEF SUMMARY OF THE INVENTION

In accordance with the present invention, the above and other problems are solved by a method, system, apparatus, and computer-readable medium for providing automated additional living expense management and tracking. Through the use of the embodiments of the invention, computer users familiar with a web browser application program and a spreadsheet application program can create and manage intelligent automated additional living expense worksheets. The additional living expenses can then be evaluated utilizing the data from the spreadsheet and viewed by users utilizing a web browser application program.

According to an embodiment of the invention, a system is provided for administering a spreadsheet-driven additional living expense calculator including a graphical visual interface adapted to receive input of and display a plurality of additional living expense related values; an external data module for communicating one or more additional living expense related values for display on the graphical visual interface; a validation engine for validating the additional living expense values, the validation engine configured to compare a plurality of additional living expense input values with a plurality of additional living expense reference values, and to provide a visual indication based upon one or more of the comparisons; a calculation module for determining one or more payment values based on the validated additional living expense values; and a payment module for providing instructions related to payment of the calculated additional living expense values.

According to another embodiment of the invention, a computer implemented method for administering an additional living expense worksheet includes invoking, via a interactive user interface, the additional living expense worksheet, the worksheet being retrieved from a electronic repository. The computer implemented method also includes receiving additional living expense related data via the interactive user interface for association with one more cells in the additional living expense worksheet; validating, via a processor, the received additional living expense related data to determine at least if the data falls within a predetermined permissible data range; calculating, via the processor, at least one total amount for the validated additional living expense related data and issuing a communication, via a communications module, related to the at least one total amount.

According to a further embodiment of the invention, computer-readable storage medium has computer-executable instructions stored thereon which, when executed by a computer, perform a method for providing a spreadsheet-driven additional living expense calculator for a plurality of living expense categories. The method executed by the computer-executable instructions comprising receiving data related to current living expenses for the living expense categories; retrieving data associated with previous and normal living expenses for the living expense categories; storing and displaying the current, previous and normal living expense data; validating the living expense data for the living expense categories; and issuing a communication related to the validated living expense data for the living expense categories.

The invention may be implemented as a computer process, a computing system, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features, as well as advantages, which characterize the present invention, will be apparent from a reading of the following detailed description and a review of the associated drawings.

### BRIEF DESCRIPTION OF THE DRAWINGS

FIG. 1 is a computer system architecture diagram illustrating a computer system provided by and utilized in the various embodiments of the invention;

FIG. 2 is a representative diagram illustrating an additional living expense system in use provided by and utilized in the various embodiments of the invention;

FIG. 3 is a network architecture diagram illustrating an illustrative operating environment for embodiments of the invention;

FIG. 4 is a process diagram showing aspects of an illustrative process for providing spreadsheet-based additional living expense calculators;

FIG. 5 is an exemplary screen diagram illustrating a display screen provided by the various aspects of the invention;

FIG. 6 is another exemplary screen diagram illustrating a display screen provided by the various aspects of the invention; and

FIG. 7 is an exemplary process diagram showing aspects of an illustrative process for providing spreadsheet-based additional living expense calculators.

### DETAILED DESCRIPTION OF THE INVENTION

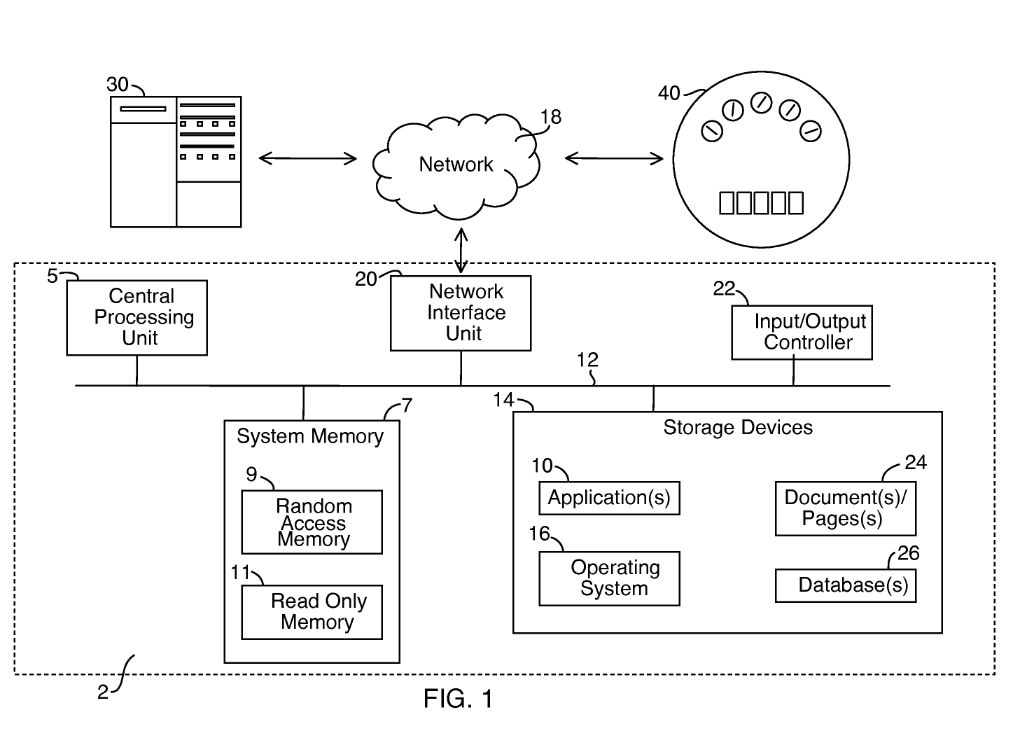

Referring now to the drawings, in which like numerals represent like elements, various aspects of the present invention will be described. In particular, FIG. 1 and the corresponding discussion are intended to provide a brief, general description of a suitable computing environment in which embodiments of the invention for creating, managing and tracking additional living expenses may be implemented. As used herein the terms “additional living expense” or “additional living expenses” may refer to a single additional living expense calculation, or to a plurality of additional living expense calculations for a single policyholder or a plurality of policyholders. Generally, living expense categories may include electric, gas, water, rent, hotel, food, cable, internet and other related living expenses. While the invention will be described in the general context of program modules that execute on server and personal computer systems, those skilled in the art will recognize that the invention may also be implemented in combination with other types of computer systems and program modules.

The present invention provides insurance claim adjusters, handlers and representatives either from an insurance company or third party administrator perspective with the ability to intelligently, efficiently and automatically input, calculate and manage additional living expense payments for a variety of policyholders. Utilizing the present invention, prior laborious and manual additional living expense calculations are automated and the integrity of the data is vastly improved through integrated acquisition and validation. Benefits of the present invention also extend to policyholders who now can receive quicker and more accurate payments related to the additional living expenses they have incurred. Acquisition and validation may be performed using a variety of sources such as utility company databases and meters, and/or through use of insurance company historical databases of claims and payments.

Generally, program modules include routines, programs, components, data structures, and other types of structures that perform particular tasks or implement particular abstract data types. Moreover, those skilled in the art will appreciate that the invention may be practiced with other computer system configurations, including hand-held devices such as smart phone or personal digital assistant type devices, multiprocessor systems, microprocessor-based or programmable consumer electronics, minicomputers, mainframe computers, and the like. The invention may also be practiced in distributed computing environments where tasks are performed by remote processing devices that are linked through a communications network such as a variety of insurance claim adjuster or claim handler workstations in communication with a central insurance server and one or more third party databases or servers such as those belonging to one or more utility companies or housing providers. In a distributed computing environment, program modules may be located in both local and remote memory storage devices.

Referring now to FIG. 1, exemplary computer architecture for a computer or computing device 2 utilized in the various embodiments of the invention will be described. The computer architecture shown in FIG. 1 illustrates a desktop, cell-phone, laptop or other portable or handheld computing device such as a personal computer or intelligent portable computing device operated by a field or home office claims adjuster or claims handler, including a central processing unit 5 (“CPU”), a system memory 7, including a random access memory 9 (“RAM”) and a read-only memory (“ROM”) 11, and a system bus 12 that couples the memory to the CPU 5. A basic input/output system (BIOS) containing the basic routines that help to transfer information between elements within the computer, such as during startup, is stored in the ROM 11. The computer 2 further includes a physical or virtual mass storage media or device 14 for storing application programs 10 such as a Web browser for accessing a spreadsheet based application for calculation, management and administration of additional living expenses, an operating system 16, and other program modules, which will be described in greater detail below.

The mass storage device 14 is connected to the CPU 5 via bus 12. The mass storage device 14 and its associated computer-readable media provide non-volatile storage for the computer 2. Although the description of computer-readable media contained herein refers to a mass storage device, such as a physical or virtual hard disk or CD-ROM drive, it should be appreciated by those skilled in the art that computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, ROM, RAM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet or other wide area or local area network both wired, wireline and combinations thereof. The computer 2 may connect to the network 18 through a network interface unit 20 connected to the bus 12. It should be appreciated that the network interface unit 20 may also be utilized to connect to other types of networks and remote computer systems, such as for issuing electronic instructions or communications such as wire transfer instructions which may include account information such as name, account number and bank routing number. Communications may also include electronic mail messages or text type messages in the SMS or MMS formats.

Referring still to FIG. 1, the computer 2 may also include an input/output controller 22 for receiving and processing input from a number of other devices, including a keyboard, mouse, or electronic stylus (not shown in FIG. 1). Similarly, an input/output controller 22 may provide output to a display screen, a printer, or other type of output device.

As mentioned briefly above, a number of program modules and data files may be stored in the mass storage device 14 and RAM 9 of the computer 2, including an operating system 16 suitable for controlling the operation of a networked personal computer. The mass storage device 14 and RAM 9 may also store one or more program modules. In particular, the mass storage device 14 and the RAM 9 may store a web browser application program 10. In exemplary embodiments, application program 10 such as a web browser is operative to request, receive, render, and provide interactivity with electronic documents via a graphical user interface, such as web page data 24 that have been formatted for use with the web browser 10. Moreover, the web browser application program 10 may be operative to execute scripts contained in the web pages 24. It should be appreciated, however, that other web browser application programs from various manufacturers may be utilized to embody the various aspects of the present invention.

As will be described in greater detail below, the web pages data 24 may comprise data related to pages for creating, editing, tracking and viewing additional living expense worksheets in accordance with the present invention. Additional living expense worksheets may be representative of a single claimant or policyholder or multiple claimants or policyholders. In particular, the web pages 24 may include code, macros, HTML and scripts which, when displayed by the web browser application 10, provide a spreadsheet-based user interface for entering additional living expense input values and for displaying the additional living expense input values. Additional details will be provided below regarding the format, construction, and use of the web pages 24.

As discussed in more detail later herein, additional living expense worksheets may also be based at least partially on additional living expense related values, such as, for example, information received from one or more of third-party data sources 30 and 40 via the network 18 and/or linked to via the web pages 24. Each of third-party data sources 30 and 40 may comprise any number and type of systems for storing data, including but not limited to relational databases, application servers, and spreadsheets. “Third-party”, as used herein, refers to a party or entity external to a user of one of devices 2.

Third-party data sources 30 and 40 may be operated by more than one third party, and a single third party may operate more than one of data sources 30 and 40. Access to one or more of third-party data sources 30 or 40 may or may not be fee-based. Third-party data sources 30 or 40 may include billing information, utility information, usage information and/or any other suitable data sources for use in conjunction with some embodiments. For example, third party data source 30 may be a database, maintained by an electric utility company, which provides monthly billing data for inclusion in an additional living expense worksheet. In another example, third party data source 40 may be an actual usage meter, such as a water meter, electric meter, phone meter or other which is configured to provide usage information to the additional living worksheet. Selected information from third-party data sources 30 and 40 may be compiled into a database 26 stored in the mass storage device.

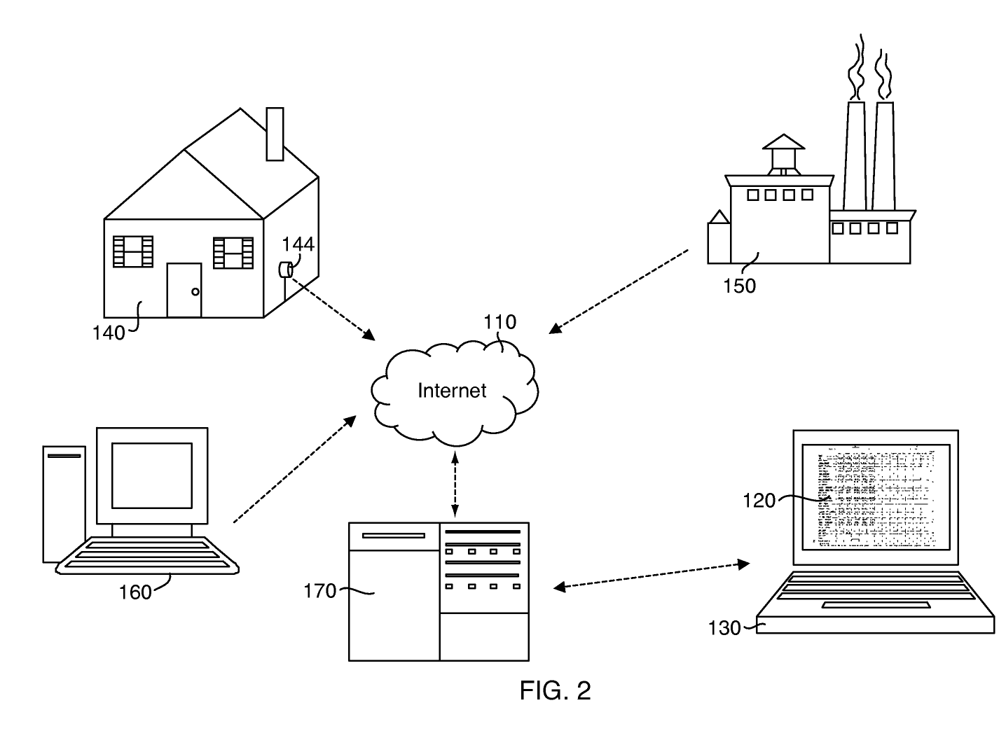

Referring now to FIG. 2, which illustrates an overall operational system diagram of the present invention in which different devices and subsystems are in communication with one another, the elements illustrated in FIG. 2 may be connected to a central or distributed communication network such as the internet 110 for facilitating the management and administration of additional living expense worksheets 120 being displayed and manipulated on a claims adjuster workstation 130. In the embodiment of the invention illustrated, a policyholder's house or primary residence 140 may have a utility meter 144 that is configured to transmit usage information to network 110. Utility meter 144 could be any of a variety of different types of meters for measuring different types of consumer commodities, such as gas, water, electricity, cable, telephone of other types of similar commodities. In an exemplary embodiment of the present invention utility meter 144 includes a transceiver or transmitter for transmitting data from the utility meter to a remote location via network 110. As further illustrated in FIG. 2, a utility company 150 may also be in communication with workstation 130 for providing either current or historical living expense information for inclusion in additional living expense worksheet 120. Workstation 130 may also be in communication with another remote computer or workstation 160 such as an apartment building or hotel workstation, computer or subsystem for providing temporary living information for inclusion in additional living expense worksheet 120. In one embodiment, utility meter 144 and/or utility company 150 may transmit information related to actual home usage information for water, electric and cable additional living expense categories. Computer 160 may transmit information related to rental unit water, electric and cable additional living expense categories. Such foregoing information may be aggregated into a database by a central server 170, such as a server operated by an insurance company.

Referring still to FIG. 2, communications between workstation 130 and home 140, utility company 150, computer 160 and server 170 can be established using wire-based and/or wireless methods including, but not limited to, radio frequency connections, electrical connections, and light connections (e.g., an infrared connection, and/or a fiber optics type connection). Similarly, each of the various networks and intranets illustrated may be established using any desired manner including through the establishment of wireless networks such as radio frequency networks. The wireless communication described herein may be established using spread spectrum techniques including techniques which use a spreading code and frequency hopping techniques such as the frequency hopping wireless technique.

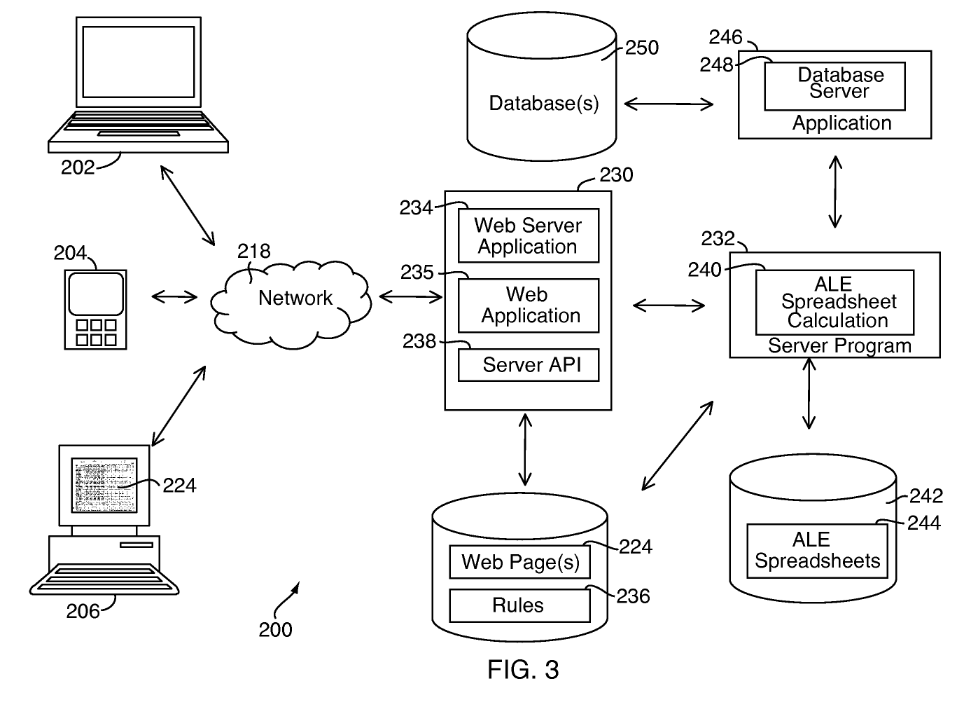

Referring now to FIG. 3, a network architecture diagram will be described that illustrates an operating environment 200 for the various embodiments of the invention. As shown in FIG. 3, one or more computers or devices 202, 204 and 206 are connected to a network 218. Also connected to the network 218 is a web server computer 230. The web server 230 comprises a server computer which may contain some or all the conventional computing components described above with respect to FIG. 1. Additionally, the web server computer 230 is operative to execute a web server application 234 for receiving and responding to requests for documents stored at or accessible to the web server computer 230. Moreover, the web server 230 is operative to receive and respond to requests for web pages generated by a web application 235. It should be appreciated that the web application 235 may comprise code executable at the web server 230, including executable code for communicating with other computers, and may also include templates, graphics, audio files, and other content known to those skilled in the art.

According to one aspect of the invention, the web application 235 is operative to provide an interface to a user of one or more of computing devices 202, 204 and 206 to create spreadsheet-based additional living expenses and to view pages showing the results of evaluated additional living expenses. In particular, the web application 235 may receive a request from the client computer 206 to create a new spreadsheet-based additional living expense. In response to the request, the web application 235 will return a web page 224 containing preformatted input and calculation fields or cells for creating a new spreadsheet-based additional living expense. An illustrative web page 224 for creating a new additional living expense worksheet will be described below. Once the user has provided the information necessary to create a new additional living expense, additional living expense validation rules 236 may be stored with the provided information. As will be described in greater detail below, the additional living expense validation rules are utilized when the additional living expense is evaluated.

Referring still to FIG. 3, a user of the computer 202 may request to create, view, edit or track one or more additional living expense worksheets. When such a request is received, the web application 235 utilizes a server application programming interface (“API”) 238. The server API 238 is operative to enable communication with a spreadsheet calculation server computer 232. The spreadsheet calculation server computer 232 is operative to execute a spreadsheet calculation server program 240. The spreadsheet calculation server program 240 comprises an executable program for retrieving and calculating spreadsheets such as the spreadsheet 244 stored in the database 242. It should be appreciated that in the embodiments of the invention described herein, the spreadsheet calculation server program 240 may include the Numbers program from Apple, Lotus 1-2-3 program from IBM and the EXCEL program from Microsoft as well as other relational databases systems and programs as known in the art. It should also be appreciated that the calculation server computer 232 may include many of the conventional hardware and software components discussed above with respect to FIG. 1.

It should be appreciated that the cells of the spreadsheet 244 may contain references to external data sources, such as a utility company database or other insurance company database. In particular, one or more of the cells of the spreadsheet 244 may contain a reference or link to a database 250 connected to a database server computer 246. In order to retrieve the data referenced by such a spreadsheet cell, the spreadsheet calculation server 240 may transmit a request for the data to a database server application 248 executing on the database server computer 246. The database server application 248 is then operative to retrieve the requested data from the database 250 and return the data to the spreadsheet calculation server 240. It should also be appreciated that the particular data returned by both the spreadsheet calculation server 240 and the database server application 248 may be dependent upon certain security credentials supplied by the user of the computer 202, 204 and/or 206 and may additionally be dependent upon consent by a policy holder and/or third party database operator to release such information.

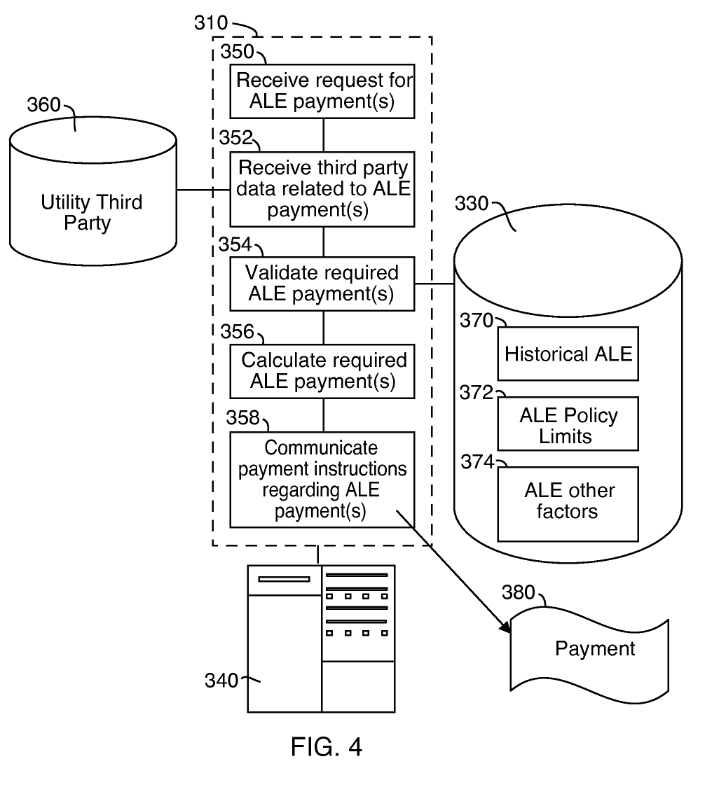

Referring now to FIG. 4, an illustrative routine 310 will be described illustrating a process for administering a spreadsheet-based additional living expense calculation. It should be appreciated that although the embodiments of the invention described herein are presented in the context of a web browser application program, the invention may be utilized in other types of application programs.

When reading the discussion of the routines presented herein, it should be appreciated that the logical operations of various embodiments of the present invention for administering and managing additional living expense worksheets are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated herein, and making up the embodiments of the present invention described herein are referred to variously as operations, structural devices, acts, actions or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

The routine 310 begins at operation 350, where a request for an additional living expense payment(s) is received via an insurance company server 340 from a policyholder or agent as discussed with reference to FIGS. 1 through 3. Typically, a claimant or policyholder will initiate a request for payment or alternatively a claims adjuster may have some reminder related to the payment request, such as on a periodic basis. Upon receipt of the request, third party data is received related to the additional living expense by operation of external module 352. Third party data may be received from one or more third party or external databases 360, such as a utility company database. The routine 310 then continues to validation engine 354, where data related to the additional living expense payment is validated. For example, validation may comprise querying an insurance company, third party administrator or other database 330 to validate the values of the key data elements in the additional living expense worksheet. Values may be validated based on comparison to certain reference values such as historical additional living expenses 370, additional living expense policy limits 372 and other related factors 374.

For example, values of the key data elements related to the total amount to be reimbursed to a policyholder may be compared with a policy limit related to such reimbursement contained in the insurance policy such as comparing the total calculated with the value equal to a percentage such as in the range of 10%-40% of primary dwelling coverage limitations, sometime referred to as “Coverage A” limits specified in the policy. Regardless of the type of validation performed, flow of the process continues to calculation module 356 to calculate a required additional living expense payment, which may comprise a computation of various additional living expense category subtotals and/or a computation of an adjusted total based on prior payments made. For example, for a individual or group of claimants, data related to living expenses such as gas, electric water, television cable, phone and/or internet is accessed or inputted. For each expense category, information related to both the current or present expense, the actual or original expense and the normal expense is aggregated. For each category, an amount due to the policyholder is then calculated by subtracting the normal data from the original data and then subtracting that data from the current data to determine an amount due for each expense category. A subtotal is calculated by summing the various amounts due for each expense category and then adjusting that subtotal by subtracting any amounts which may have been advanced for additional living expenses. Once payment is calculated, the routine 310 proceeds to payment module 358 to communicate payment instructions 380 regarding the additional living expense payment.

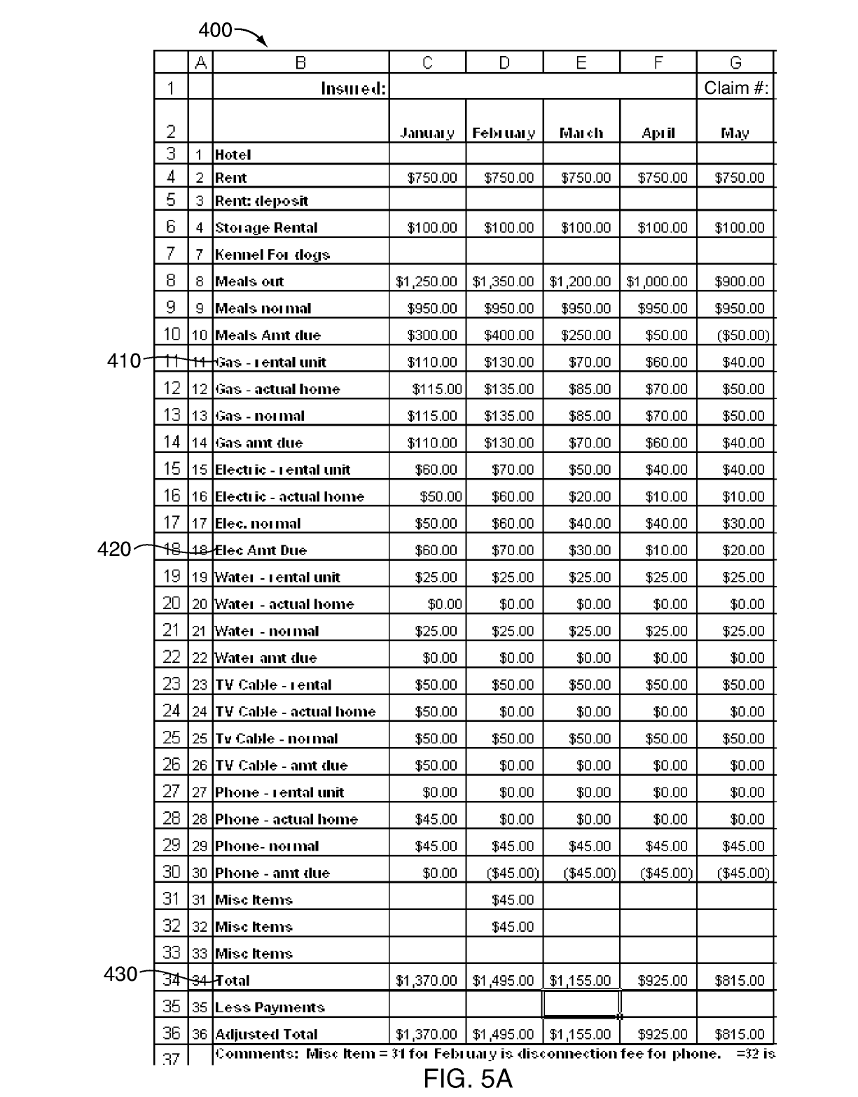

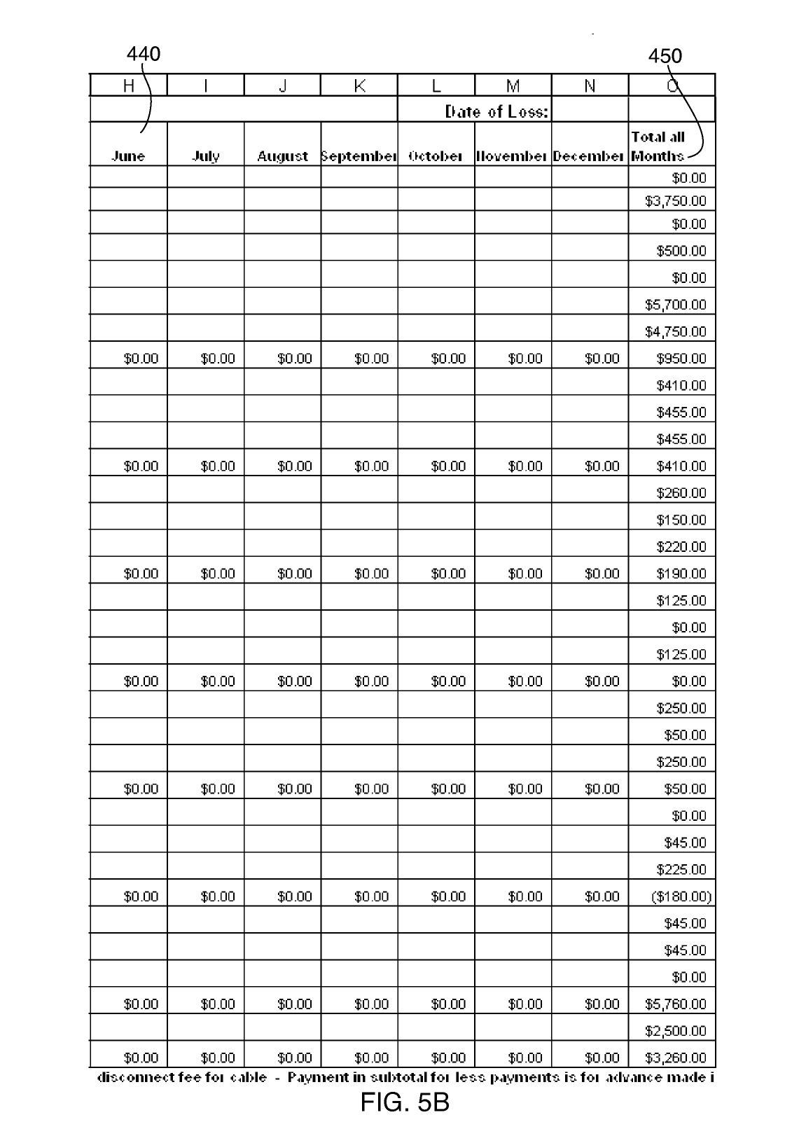

Referring now to FIG. 5, an illustrative additional living expense screen display 400 provided by an embodiment of the invention will be described such as may be rendered by server 232, as for example via the web page 224 previously described with respect to FIG. 3. In particular, FIG. 5 shows a number of additional living expenses or expense categories such as gas, electric, water, cable, and phone generated by one embodiment of the invention along with user interface items for creating new additional living expenses, editing the additional living expenses, verifying additional living expenses, for adding additional living expenses to the list, tracking existing additional living expenses and for performing other functions. Generally, screen display will be organized a series of columns and rows for intuitive management of the additional living expense data but it is contemplated other data array arrangement are possible.

As shown in FIG. 5, each additional living expense includes some visual indicia 410 which identify each additional living expense and the calculated amount due 420 for each additional living expense. Additional visual indicators 430 may distinguish certain additional living expense data from another as one line or row may be displayed in one color if indicating a subtotal or total category. Additionally, living expense screen display 400 may also include a number of different columns or sections 440 which designate certain periods, such as daily, weekly, monthly or other periods selected and corresponding totals for those periods 450 for the various additional living expenses. As discussed later herein, screen display 400 may include embedded formulas and links for data pre-population, validation and verification. For example, it is contemplated that certain cells, rows and/or columns may have data pre-populated prior to accepting input from a user such as a claims adjuster or handler. Such pre-populated data may be pre-validated to preserve the integrity of the additional living expense worksheet.

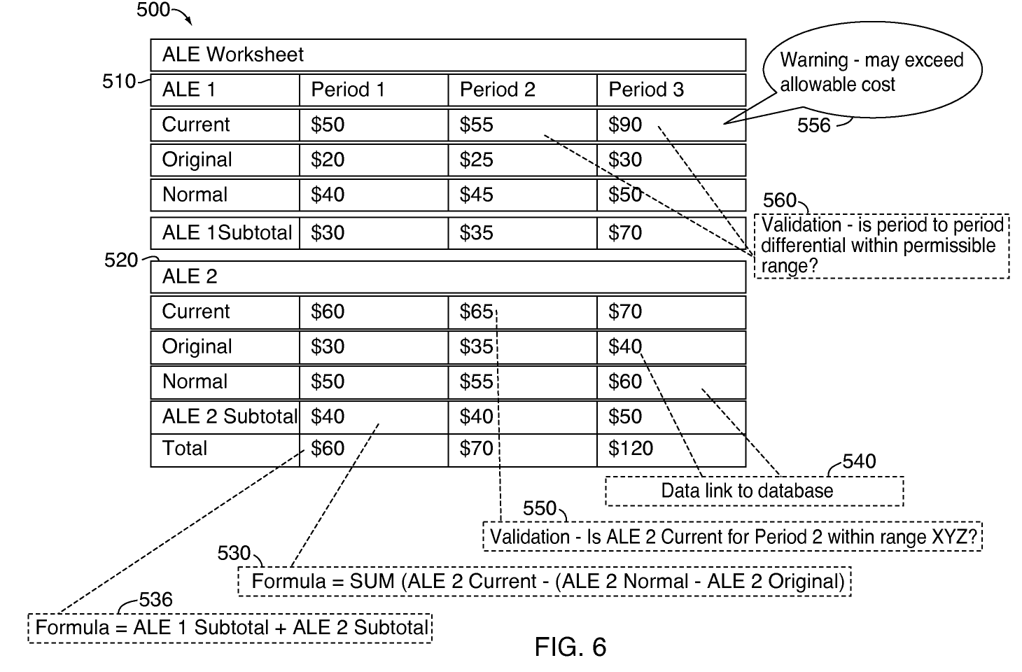

Referring now to FIG. 6, another illustrative user interface 500 will be described for utilizing a spreadsheet-based additional living worksheet in accordance with the present invention. As illustrated in FIG. 6, a number of fields are provided through which a user can enter information related to new or existing additional living expense categories such as ALE 1 designated as 510 and ALE 2 designated as 520. ALE 1 and ALE 2 may correspond to any single or number of additional living expense categories such as gas, electric, water, cable and/or phone as illustrated in FIG. 5. Referring still to FIG. 6, user interface 500 may also include a number of embedded or pre-programmed formula fields such as field 530 which contains a formula for computing the subtotal amount of the appropriate additional living expense payment for that payment category. In certain embodiments, one example of such a formula would be =SUM (ALE 2 Current−(ALE 2 Normal−ALE 2 Original) for determining the permissible subtotals for additional living expense payout.

Referring still to FIG. 6, user interface 500 may also include a number of other formula fields such as field 536 which contains embedded formulas for computing total or aggregate amounts due to a policyholder for additional living expenses. For example, the following formula =ALE 1 Subtotal+ALE 2 Subtotal may be used for determining total payouts related to a certain policyholder or claimant. It is contemplated that any number of categories may be used for calculating a total such as in the following formula =ALE Xi Subtotal . . . +ALE Xn Subtotal where n equals the total number of additional living expense categories. A number of fields or cells within interface 500 may also be linked to certain databases for pre-filing or pre-populating such as fields 540 which may pre-fill with data for the respective additional living expense category. In some embodiments, predictive and historical based algorithms may be also used to establish data values for the additional living expense worksheet such as for populating the normal fields for each additional living expense category.

Referring again to FIG. 6, validation may also be performed in interface 500 such as in field 550 where data may be validated based on a number of pre-specified rules or conditions such as whether the data in the field is within a certain range or inside or outside a pre-determined threshold. Such ranges or thresholds may be based on historical trend data from the same policyholder or aggregated historical data from a number of policyholders such as described with respect to historical additional living expense data 370 in database 330 in FIG. 4. Referring still to FIG. 6, interface 500 may also incorporate one or more warning screens 556 which signal a user in the event data fails or approaches a validation threshold. Validation may also be performed in interface 500 such as validation between related fields in the worksheet such as in fields 560. Validation may be based on permissible ranges or differentials as between certain fields or cells, such as if the difference between periods, such as between Periods 2 and 3 for the current ALE1 figures exceeds a certain dollar value. Such validation may be linked to an error or fraud process workflow in the event a certain threshold is breached. It should be appreciated that, according to embodiments of the invention related to validation, any number of values or data fields may be specified and compared to the specified thresholds, limits or ranges. Additionally, any number of different visual or audible indicators may be provided to indicate the relationship between the data and values and the validation ranges and thresholds.

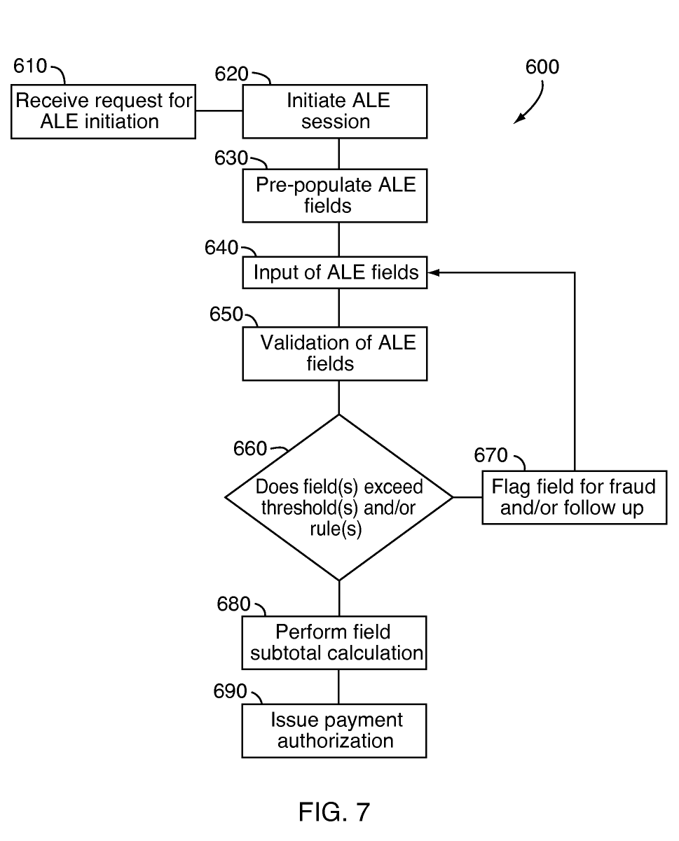

Turning now to FIG. 7, an illustrative routine 600 will be described for initiating a session for creating and managing a spreadsheet-based additional living expense worksheet. The routine 600 begins at operation 610, where a request is received for an additional living expense worksheet initiation. In response to the request, an additional living expense worksheet session is initiated via operation 620. The routine 600 then continues to operation 630, where one or more additional living expense related values are pre-populated or pre-filled which may include retrieving data from a database server application as discussed earlier herein to reference external data contained in one or more external databases. The routine 600 then continues to operation 640 whereby one or more additional living expense fields or cells are inputted, such as by a claims handler or adjuster associated with a third party administrator or insurance company. Routine 600 continues to operation 650, where one or more worksheet fields or cells are validated. Validation may proceed in operation 660 to determine if a field value exceeds a threshold or rule(s). If so, then the field is flagged for fraud or error or for follow up in operation 670. Flagging may include displaying of a warning screen or window or also preventing input of the actual value. Flagging may also result in a default permissible value being inputted instead of the value which resulted in the flagging. Additionally, the flagging may include a communication being transmitted to one or more regulatory entities, such as a compliance organization and/or making an entry in a digital claim file related to the underlying insurance policy or claimant. If it is determined that the filed value does not exceed a threshold or rule, then one or more subtotal or totals are calculated or re-calculated in operation 680.

Routine 600 further continues with the issuance of a payment authorization or payment instructions as shown in operation 690. Authorization may be in the form of an electronic communication to a finance division of an insurance company and/or a communication directly to a financial institution or bank with instruction for payment to one or more policyholders. To further the above objects, the communication may interface with one or more funds transfer system for facilitating electronic funds transfer between a banking system of a payor insurance company and an account of a payee policyholder. Such a system may include a trusted third or intermediary party structured to communicate with both the insurance banking system and a bank of the payee maintaining payee's account. Such communications may include information as to accurately identify routing/transit number of the payee's bank and the payee's account number to facilitate payment in accordance with payor's payment order to payee's account. In the present invention, the payee may be a policyholder of a property and casualty type of insurance, a utility company, a designee of the foregoing and or other party authorized to receive payment related to the additional living expense.

Accordingly, as is shown and described, the present invention for the efficient and intelligent management and administration of additional living expense eliminates many of the disadvantages of current additional living expense calculation, administration and management processes as well as providing insurance companies with an efficient and expedited way to manage and pay these additional living expenses promptly to policyholders who will benefit from the prompt and accurate payments.

Based on the foregoing, it should be appreciated that the various embodiments of the invention include a method, system, apparatus, and computer-readable medium for providing spreadsheet-based additional living expense calculators. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computerized system for administering and managing additional living expense payments under an insurance policy comprising:
one or more processors configured to provide: a graphical user interface adapted to receive one or more additional living expense input values and to display the one or more additional living expense input values;
an external module adapted to automatically receive the one or more additional living expense related values;
a validation engine for validating at least the additional living expense input values, the validation engine configured to compare a plurality of the additional living expense input values with a plurality of additional living expense reference values and to provide a visual indication on the graphical user interface based upon one or more of the comparisons;
a calculation module for determining one or more payment values based on at least the validated additional living expense input values, the calculation module configured to determine payments due for a plurality of additional living expense categories utilizing a current expense, an original expense and a normal expense associated with each additional living expense category; and
a payment module for providing instructions related to payment of the calculated additional living expense values.

2. The system of claim 1, wherein the instructions related to payment identify a routing/transit number and an account number of an insurance policyholder.

3. The system of claim 1, wherein the graphical user interface comprises at least in part a spreadsheet having one or more embedded reference links to one or more third party databases which are automatically accessed via external data module.

4. The system of claim 1, wherein the processor is further configured to provide a communications module for communicating messages responsive to the validation being performed.

5. The system of claim 4, wherein the external data module interfaces with a historical database of additional living expense values.

6. The system of claim 1, wherein the external data module interfaces with a utility meter.

7. The system of claim 1, wherein the calculated payment values are calculated by subtracting the current expense from the difference between the normal expense and the original expense associated with each additional living expense category.

8. The system of claim 7, wherein the additional living expense input values include at least three of rental, electricity, gas, water, phone and cable/internet living expenses.

9. The system of claim 8, wherein the external data module interfaces with a utility provider of at least one of the electricity, gas, water, phone and cable/internet services.

10. The system of claim 9, wherein the payment instructions include an account number and a bank routing number associated with the utility provider.

11. The system of claim 1, wherein the additional living expense reference values relate to a percentage of an insurance policy coverage limit for additional living expense reimbursement.

12. A computer-readable storage medium having computer-executable instructions stored thereon which, when executed by a computer, perform a method for providing a spreadsheet-driven additional living expense calculator for a plurality of living expense categories, the method executed by the computer-executable instructions comprising:
receiving data related to living expenses for a plurality of living expense categories;
retrieving external data associated with the living expenses for the living expense categories for pre-populating at least a portion of the spreadsheet;
displaying the pre-populated living expense data in the spreadsheet;
receiving input of additional living expense data;
validating the living expense data for the living expense categories; and
issuing an electronic communication related to the validated living expense data for the living expense categories.

13. The computer-readable storage medium of claim 12, wherein the data related to living expenses is received from one or more third party vendor databases containing historical data related to the living expenses.

14. The computer-readable storage medium of claim 12, wherein the communication is an electronic mail message addressed to an insurance policyholder.

15. The computer-readable storage medium of claim 14, wherein the communication includes an instruction for payment to a third party bank.

16. The computer-readable storage medium of claim 12, wherein the communication is an electronic mail message addressed to an insurance claims adjuster.

17. The computer-readable storage medium of claim 13, wherein validating the living expense data for the living expense categories comprises comparing the living expense data to one or more predetermined reference ranges, wherein the reference ranges are based on historical data for the respective expense category.

18. The computer-readable storage medium of claim 17, wherein validating the living expense data for the living expense categories comprises issuing a warning if data for one or more of living expense categories exceeds a predetermined category threshold.

19. A computer implemented method for administering an additional living expense worksheet, the computer implemented method comprising:
initializing, via an interactive user interface, the additional living expense worksheet, the worksheet being retrieved from a electronic repository;
receiving additional living expense related data via the interactive user interface for association with one more cells in the additional living expense worksheet;
validating, via a processor, the received additional living expense related data to determine at least if the data falls within a predetermined permissible data range;
calculating, via the processor, at least one total amount for the validated additional living expense related data and
issuing a communication, via a communications interface, related to the at least one total amount.

20. The computer implemented method of claim 19, wherein validating further comprises accessing a validation rules engine containing one or more validation rules related to the additional living expense related data.
